(19) United States
(12) Patent Application Publication
(10) Pub. No.: US 2007/0004812 A1
(43) Pub. Date: Jan. 4, 2007

(54) Method of treating a rubber containing waste material

(75) Inventors: Joachim Karthäuser, Sollentuna (SE); Henry Kierkegaard, Skodsborg (DK)

Correspondence Address: BUCHANAN, INGERSOLL & ROONEY PC, POST OFFICE BOX 1404, ALEXANDRIA, VA, 22313-1404, US

(73) Assignee: NANON A/S, Brondby (DK)

(21) Appl. No.: 10/570,274

(22) PCT Filed: Sep. 2, 2004
(86) PCT No.: PCT/DK04/00586

§ 371 Date: Apr. 10, 2006

(30) Foreign Application Priority Data
Sep. 2, 2003 (DK) PA2003 01260

(51) Int. Cl. C08J 11/04

(52) U.S. Cl. 521/40

(57) ABSTRACT

The invention relates to a method of providing a rubber material from a rubber containing waste material. The method comprises the step of subjecting the waste material to a treatment with an extraction solvent in a reactor at a pressure above atmospheric pressure, wherein the extraction solvent comprises an effective amount of carbon dioxide. The extraction may be performed in one or more dynamic and/or one or more static steps, to provide a sufficient extraction without damaging the material. The rubber containing waste material may further be subjected to an impregnation step, which may be performed simultaneously with the extraction step, after the extraction step or overlapping with the extraction step. The invention also relates to a rubber material comprising low amounts or is essentially free of alkylated aromatic oils and heavy metals in the form of inorganic and organic salts.

### TECHNICAL FIELD

The present invention relates to a method of providing reusable rubber from a rubber containing waste material by treatment of the rubber containing waste material: The invention therefore also relates to the rubber material obtainable by the treatment and use thereof.

### BACKGROUND ART

A large amount of waste rubber material, e.g. in the form of scrap tyres and other, is discarded every year in the world. It is estimated that the number of scrap tyres discarded in America reaches 270 million and the amount of discarded scrap tyres in the world reaches 15 million tons (1 billion tyres) annually. However, it is difficult to reuse waste rubber products and usually the process of reusing waste rubber causes a second pollution. At present, scrap tyres are the cause of serious environmental pollution; but they are also a huge resource. How to reuse or recycle the waste rubber products is not only an important social issue related to preventing pollution but also an important economic issue related to reusing resources.

Scrap tyres are today used in cement production and in pyrolysis where simply the energy content of rubber is used. Further uses are in downgraded rubber products, export, and use as such in e.g. harbor or agricultural construction. One outlet, in the range of 10-20% of the total volume, is the milling of rubber to granulate following the removal of steel and other tyre components. Milling may be performed “warm” or “cryogenic”. This rubber powder, granulate or crumb is used in areas such as (i) asphalt modification, (ii) moulded products, (iii) tyres/automotive, including brakes/friction market and (iv) sport and playground surfacing, to name the largest markets. In the USA, some 300 000 tons are consumed as rubber granulate annually.

The main problem of the prior art is the fact that residues remain in the product. These residues consist of oil including alkylated aromatics and various heavy metals in the form of inorganic and organic salts, such as grease. Residues constitute, depending on the rubber, about 3-10% of the total mass. The residues are necessary for the performance of the tyres, but are a potential environmental burden in later use as recycled material.

The presence of oil and grease further makes the rubber granulate smell unpleasantly, and the adhesion of rubber granules to any matrix—asphalt, plastic, recycled tyre, paint—is weak due to the presence of oil. In particular, re-vulcanisation of the granulate to virgin rubber is difficult if the surface which should react chemically with virgin rubber is “protected” by oil layers.

The objective of the invention is to provide a method of treating the rubber waste for obtaining a reusable rubber material, which method and which rubber material do not have all the drawbacks as described above.

A particular objective it to provide a method of producing a rubber material from rubber containing waste material, which rubber material results in reduced pollution compared with prior art product.

A further objective is to provide a method of producing a rubber material from rubber containing waste material, by use of which method rubber material with a highly reduced content of undesired and possibly polluting residues such as-oils and heavy metals is obtained.

An additional objective is to provide a novel rubber material having excellent mechanical properties and simultaneously a low content of undesired residues such as oils and heavy metals.

These objectives have been achieved by the invention as defined in the claims and described in the following.

### DISCLOSURE OF INVENTION

The method according to the invention or according to desired embodiments of the invention has further shown to have a number of related advantages:
a) Extraction of granulate using high pressure gas is highly effective and economical as compared with extractions using organic solvents.
b) Waste management is significantly simpler by using the method of the invention: no solvent handling, no solvent emissions, all extracted oils and other can be collected after carbon dioxide removal by distillation.
c) Impregnation using monomers in desired embodiments may be carried out in inert atmosphere, reducing the exposure risk for operating personnel.
d) Smelling problems related to rubber waste is highly reduced or even removed by using the method of the invention. In one embodiment, extracted rubber material in the form of granulates is essentially non-smelling due to the absence of residues. Therefore in-door (flooring) and agricultural (animal bedding) and sport ground applications are more attractive, i.e. the value in use of the granulates is increased.
e) The adhesion to other materials of rubber material obtained using the method of the invention is increased as the oily film present on the granules -is removed. Adhesion of rubber granulates obtained by the method of the invention to any matrix e.g. to itself is therefore increased. Therefore, merely extracted material can be vulcanized into virgin rubber, allowing an increased concentration of recycle granulate into tyres and other rubber products (currently lower than 3%) as well as asphalt (roofing felt, water-proofing membranes, road asphalt).
f) The adhesion of impregnated or modified rubber granulate (styrene, epoxy and the like) obtained in one embodiment of the invention is greatly improved in comparison with raw granulate and even in comparison with the extracted but not impregnated granulate. This allows increase in filler concentrations without compromising specified mechanical strength and other specifications for e.g. moulded or extruded products. Equally, applications in high performance asphalt types (bridge membranes and the like) are possible.
g) The impregnation of for example styrene in one embodiment will enable a lighter colour of the powder/granulate and hence this can be used as filler material in lighter coloured materials.

The method of providing a rubber material from a rubber containing waste material according to the invention comprises the step of subjecting the waste material to a treatment with an extraction solvent in a reactor at a pressure above atmospheric pressure, such as at least 5 bars, or even higher. The extraction solvent comprises an effective amount of carbon dioxide, where the term “effective amount” means that an extraction is taking place, e.g. residues in an amount of at least 0.1% by weight of the rubber waste material is extracted after an extraction time of 20 minutes. In general, it is desired that the major part by weight of the extraction solvent is carbon dioxide, and in preferred embodiments the extraction solvent comprises at least 80% by weight of carbon dioxide.

It is in general preferred that the pressure during the extraction step is within the interval 5-300 bars.

The pressure may be kept constant or it may be varied during the extraction step. For keeping the cost as low as possible the pressure should not be higher than necessary for the extraction, and thus the pressure may not vary too much during the extraction.

Thus, in one embodiment of the method according to the invention the pressure is essentially constant during the extraction step, the pressure preferably being at least 10, bars, such as at least 20 bars, such as between 30 and 300 bars, such as between 40 and 200 bars.

In another embodiment of the method according to the invention the pressure varies during the extraction step, the pressure preferably being at least 10, bars, such as at least 20 bars, such as between 30 and 300 bars, such as between 40 and 200 bars.

In one embodiment of the method according to the invention the pressure is raised relatively quickly to its maximum, such as within 15 minutes or even within 10 or 5 minutes, and from this maximum pressure point the pressure is maintained for a period and then it drops slowly, e.g. as explained later, until the pressure reaches atmospheric level.

In order to have a true extraction, and not just a minor uncontrolled evaporation, the reactor should either be very large and the pressure high, or the rubber containing waste material should be subjected to a flow of solvent through the reactor.

Thus, in one embodiment of the invention the extraction step comprises subjecting the rubber containing waste material to a flow of the extraction solvent. The average solvent flow through the reactor during the extraction step should preferably be at least 0.1 L/min per kg rubber containing waste material, such as at least 0.5 L/min per kg rubber containing waste material, such as at least 1.0 L/min per kg rubber containing waste material, such as at least 2.0 L/min per kg rubber containing waste material, such as at least 5.0 L/min per kg rubber containing waste material, wherein the volume of the solvent is determined at 50 bars.

In a preferred embodiment of the invention the extraction step comprises subjecting the rubber containing waste material to a flow of the extraction solvent. The average solvent flow through the reactor during the extraction step should preferably be at least 0.1 kg/min per kg rubber containing waste material, such as at least 0.5 kg/min per kg rubber containing waste material, such as at least 1.0 kg/min per kg rubber containing waste material, such as at least 2.0 kg/min per kg rubber containing waste material, such as at least 5.0 kg/min per kg rubber containing waste material.

The average flow through the reactor is determined as the amount of solvent which is flowing into the reactor or if it is flowing out, the amount of solvent flowing out of the reactor. Preferably the amount of solvent which is flowing into the reactor is between 95 and 105% by weight of the amount of solvent that is flowing out of the reactor during at least one dynamic extraction step of the total extraction step.

The amount of solvent which is flowing out of the reactor includes the extracted matter.

In one embodiment of the method according to the invention, the extraction step comprises subjecting the rubber containing waste material to a dynamic extraction by providing a continuous flow through the reactor of the extraction solvent. By the term ‘continuous flow’ is meant that there is a continuing flow of solvent into the reactor and a continuing flow of solvent out of the reactor. The in and out flow may be constant or it may vary.

The average solvent flow during the dynamic extraction step may e.g. be as disclosed above. In one embodiment, it is desired that the solvent flow through the reactor is essentially constant during the dynamic extraction step. In one embodiment, it is desired that the solvent flow through the reactor does not go below 1.0 kg/min per kg rubber containing waste material, preferably not even below 0.5 kg/min or even not below 0.1 kg/min per kg rubber containing waste material.

In one embodiment, the extraction step (which means the total extraction steps which may include sub steps) includes at least one static extraction step, where there is essentially no flow through the reactor.

In one embodiment, the extraction step comprises subjecting the rubber containing waste material to a stepwise static extraction by providing at least one stepwise change of solvent between static extraction steps. This means that one static extraction step is followed by another static extraction step, with an intermediate change of some of the solvent. In order to change solvent there must be established a solvent flow through the reactor. In one embodiment, the stepwise change of solvent includes that at least 25% by volume, such as at least 50% by volume, such as at least 60% by volume, such as at least 70% by volume, such as at least 80% by volume such as at least 90% by volume such as approximately 100% by volume of the solvent in the reactor is changed. For changing e.g. 50% by volume, the amount of solvent that is flushed through the reactor will approximately be around 100% of the reactor volume and etc.

In one embodiment, it is desired that the stepwise change of solvent between static extraction steps includes a flow of solvent through the reactor over a stepwise change period whereby the flow of solvent through the reactor includes at least 50% by volume, such as at least 75% by volume, such as at least 100% by volume, such as at least 200% by volume such as at least 300% by volume, such as approximately 400% by volume of the solvent in the reactor prior to the stepwise change period.

In one embodiment, the stepwise change period should be relatively short, since if it is longer it will itself constitute a dynamic extraction step. The stepwise change period may thus preferably be less than 3 minutes, such as between 0.5 and 2 minutes.

In one embodiment, the stepwise change of solvent between static extraction steps includes a flow of solvent into the reactor over a stepwise change period between a first and a second static extraction period, wherein at least one of the first and the second static extraction periods being as long or longer than the stepwise change period.

In one preferred embodiment, the extraction step comprises subjecting the rubber containing waste material to a combined dynamic and static extraction by providing a continuous flow of the extraction solvent during the dynamic extraction and essentially no solvent flow at the static extraction. By optimizing the length of the dynamic and the static extraction periods the effectivity and the cost of the extraction can be optimized.

In one embodiment, the extraction step comprises at least one, such as 2, 3, 4, 5, 6 or more static extraction steps, and each static extraction step is performed for a static extraction step period which is 1 minute or more, such as 5 minutes or more, such as 10 minutes or more, such as 15 minutes or more, such as 20 minutes or more, such as 25 minutes or more, such as 30 minutes or more. If the static extraction step is too long, the extraction will cease. Thus, in general it is desired that the static extraction step or each static extraction step should be sufficiently short to avoid ceasing the extraction until final termination is desired.

In one embodiment, the extraction step comprises at least 2 static extraction steps, each static extraction step being performed for a static extraction step period, wherein the static extraction step periods have a length which is equal or different from each other. In one embodiment, the static extraction step periods increase in length from one static extraction step period to a subsequent static extraction step, more preferably several of the static extraction step periods are followed by longer subsequent static extraction steps. Thereby an optimal effectivity in combination with an effective use of solvent can be obtained.

In one embodiment, the extraction step comprises at least one, such as 2, 3, 4, 5, 6 or more dynamic extraction steps. Each dynamic extraction step may preferably be performed for a dynamic extraction step period which is 3 minutes or more, such as 5 minutes or more, such as 10 minuts or more, such as 15 minutes or more, such as 20 minutes or more, such as 25 minutes or more, such as 30 minutes or more.

In one embodiment, the extraction step comprises at least 2 dynamic extraction steps, and each of these dynamic extraction step is performed for a dynamic extraction step period, wherein the dynamic extraction step periods have a length which is equal or different from each other. In one embodiment, the dynamic extraction step periods decrease in length from one dynamic extraction step period to a subsequent dynamic extraction step, more preferably several of the dynamic extraction step periods are followed by shorter subsequent dynamic extraction steps. Thereby an optimal effectivity in combination with an effective use of solvent can be obtained.

In one embodiment, the extraction step comprises at least two dynamic extraction steps, and the average solvent flow through the reactor in the dynamic extraction steps is essentially equal to each other.

In one embodiment, the extraction step comprises at least two dynamic extraction steps, and the average solvent flow through the reactor in the dynamic extraction steps differs from each other, preferably the flow of solvent decreases from one extraction step to a subsequent extraction step.

According to the invention it has been observed by the inventors that by using alternating dynamic and static extraction steps an increased effectivity/cost level can be obtained. Thus it has been found that the method of using alternating dynamic and static extraction steps is more effective compared with the method of using a constant solvent flow, where the average flow for the two methods is identical.

Thus, a preferred embodiment of the method according to the invention includes an extraction step comprising alternating dynamic and static extraction steps, including at least one, such as two, three, four or more dynamic steps with a dynamic step period of at least 3 minutes, such as at least 5 minutes, such as at least 10 minutes, such as at least 15 minutes, such as at least 20 minutes, such as at least 25 minutes, such as at least 30 minutes, with intermediate static extraction step(s) with respective static extraction step periods of between 0.5 and 30 minutes, such as between 3 and 20 minutes, such as between 5 and 15 minutes.

The total extraction period may preferably be least 10 minutes, such as at least 15, such as between 20 and 120 minutes, such as between 30 and 60 minutes. The extraction time may in one embodiment be between 1 and 120 minutes, preferably between 5 and 20 minutes.

As indicated above, the reactor may in principle have any volume, but for obtaining a cost acceptable method the reactor should not be too large compared with the amount of rubber containing waste material to be treated. In general, the volume of the reactor may therefore preferably be between 1.5 and 500 L per Kg/rubber containing waste material, such as between 2 and 100 L per Kg/rubber containing waste material, such as between 2.5 and 50 L per Kg/rubber containing waste material, such as between 3 and 25 L per Kg/rubber containing waste material.

In one embodiment, the volume of the reactor is between 1.5 and 100 times, such as between 2 and 50 times, such as between 5 and 25 times the volume of the rubber containing waste material in non-compressed condition.

If the volume is too large, an excessive amount of solvent is needed, which in general is undesired due to cost.

The temperature at the extraction step may e.g. be at least 0° C., such as at least 5° C., such as at least 25° C.

In one embodiment, the carbon dioxide is in its supercritical state during at least a part of the extraction step. In one embodiment, the extraction step is carried out with the carbon dioxide in or near its supercritical state for at least 50% of the extraction time, where near its supercritical state means that the carbon dioxide is not supercritical but will become supercritical, if the pressure is increased by 10% or less, preferably by 5% or less.

It is desired that the extraction step is performed for a sufficient time to extract a substantial amount of the residues in the rubber, preferably for a sufficient time to remove at least 0.5%, such as at least 1%, such as at least 2% by weight of the rubber part of the waste. In general, the amount of removable residues in a rubber waste material is between 2 and 10% by weight. It is desired that the extraction time is sufficient to remove 90% or more of the removable residues of the rubber part of the rubber containing waste material.

In one embodiment, the extraction step is performed for a sufficient time to extract a substantial amount of the residues in the rubber, preferably for a sufficient time to remove at least 0.2%, such as at least 0.5%, such as at least 1%, such as at least 2% by weight of the rubber containing waste material.

The amount of solvent may in one embodiment be at least 0.1%, such as at least 1%, such as between 5 and 50%, such as between 10 and 500% by weight of the rubber waste material to be treated.

The extraction solvent may e.g. comprise a surfactant, preferably selected from the group consisting of hydrocarbon and fluorocarbon, more preferably having a HLB value less than 15, where the HBL value is determined according to the formula:
HBL=7+Σ(hydrophilic group numbers)−Σ(lipophilic group numbers).

Examples and descriptions of desired surfactants and their preparations can be found in U.S. Pat. No. 6,461,387 and March. J., “Advanced Organic Chemistry”, J. Wiley & Sons, N.Y. (1985) which hereby with respect to the disclosure concerning surfactants and their preparations are incorporated herein by reference.

Additional surfactants include poly(1,1′-dihydroperfluorooctyl acrylate)-b-(poly)styrene, poly(1,1′-dihydroperfluorooctyl acrylate-b-styrene), poly(1,1′-dihydroperfluorooctyl acrylate-b-methyl methacrylate), poly(1,1′-dihydroperfluorooctyl acrylate-b-vinyl acetate), poly(1,1′-dihydroperfluorooctyl acrylate-b-vinyl alcohol), poly(1,1′-dihydroperfluorooctyl methacrylate-b-styrene), poly(1,1′-dihydroperfluorooctyl acrylate-co-styrene), poly(1,1′-dihydroperfluorooctyl acrylate-co-vinyl pyrrolidone), poly(1,1′-dihydroperfluorooctyl acrylate-co-2-ethylhexyl acrylate), poly(1,1′-dihydroperfluorooctyl acrylate-co-2-hydroxyethyl acrylate), poly(1,1′-dihydroperfluorooctyl acrylate-co-dimethylaminoethyl acrylate), poly(styrene-g-dimethylsiloxane), poly(methyl acrylate-g-1,1′-dihydroperfluorooctyl methacrylate), poly(1,1′-dihydroperfluorooctyl acrylate-g-styrene), perfluorooctanoic acid, and perfluoro(2-propoxy propanoic) acid.

Other examples include perhalogenated surfactants, such as CF₃(CF₂)aCH₂CH₂C(O)OX, wherein a is between 1 and 30, polypropylene glycol surfactants, such as HO(CH₂CH(CH₃)O)i (CH₂CH₂O)iH wherein i is between 1 and 50, perhaloether surfactants, such as CF₃(CF₂CF₂O)r(CH2CH2O)tH, wherein r is between 1 and 30 and t is between 1 and 40, and polydimethylsiloxane surfactants.

The desired amount of surfactants depends on the type and the surface tension of the rubber waste but may as an example be so that the extraction solvent comprises at least 0.001 by weight, such as from 0.001 to 30% by weight, such as between 0.01 and 20% by weight, such as between 0.1 and 5% by weight of one or more surfactants. The function of the surfactants is to increase the solubility of the residues to be extracted. Furthermore, the surfactants may increase solubility of impregnation components which may be incorporated into the rubber as described below.

Additional co-solvent may also be added to increase solubility. The co-solvent may e.g. be selected from the group consisting of methane, ethane, propane, ammonium butane, n-pentane, hexanes, cyclohexane, n-heptane, ethylene, propylene, methanol, ethanol, isopropanol, benzene, toluene, xylenes, chlorotrifluoromethane, trichlorofluoromethane, perfluoropropane, chlorodifluoromethane, sulfur hexafluoride, nitrous oxide, N-methyl pyrrolidone, acetone, organosilicones, terpenes, paraffins, and mixtures thereof.

In one embodiment, the extraction solvent comprises up to about 50% by weight of co-solvent, such as between 1 and 40%, such as between 5 and 40%, such as between 10 and 30% by weight of co-solvent.

The rubber waste material may comprise other materials such at metal waste or other polymer waste. The waste material may e.g. comprise vulcanized rubber, preferably in an amount of at least 50% by weight, such as at least 75% by weight such as at least 95% by weight.

In order to increase the treatment effectivity and/or to avoid granulation after extraction treatment, it is desired to subject the rubber waste to a granulating step prior to the extraction step. Examples of granulate size are sizes in the range between 1 μm and 15 mm measured by sieving.

The granulation may preferably be performed by cutting and/or squeezing whereby the mechanical internal strength of the rubber material is maintained.

It is preferred that the rubber containing waste material is provided with its final granular size prior to the extraction step. Thereby the optimal amount of extractable residues at its final granular size can be extracted. It has thus been observed that granulation after extraction may lay bare new surfaces which may result in that residues which prior to granulation were virtually non-extractable after the granulation can easily be released. This effect may be observed for rubber containing waste material with a relatively large granular size, such as a granular size where 50% by weight of the rubber containing waste material or more is larger than 2 mm measured by sieving.

Thus it is preferred that at least 90% by weight of the rubber containing waste material, preferably at least 95% by weight of the rubber containing waste material, has a granular size of less than 5000 μm, such as between 1 and 200 μm, such as between 200 and 400 μm, such as between 400 and 700 μm, such as between 700 and 1000 μm, such as between 1000 and 1600 μm, such as between 1600 and 2500 μm, such as between 2500 and 4000 μm, such as between 4000 and 470000 μm measured by sieving prior to the extraction step, the granular size preferably being essentially unchanged during the extraction step.

In one embodiment, it is desired that at least 90% by weight of the rubber containing waste material, preferably at least 95% by weight of the rubber containing waste material, has a granular size between 100 and 500 μm measured by sieving prior to the extraction step, the granular size preferably being essentially unchanged during the extraction step.

In order to avoid undesired granulation of the rubber material during or after the extraction step, it is preferred that the pressure in the reactor is decreased sufficiently slowly. Fast or uncontrolled decreasing of pressure has shown to result in a granulation of the material with an internal destruction of the material which may lead to reduced internal strength of the rubber material.

In one embodiment, it is therefore desired that the pressure at the termination of the extraction step is regulated to atmospheric pressure sufficiently slowly to avoid damaging the rubber containing waste material.

Preferably the pressure at the termination of the extraction step is regulated to atmospheric pressure at a speed less than 10 bar/minute, such as less than 5 bar/minute, such as less than 2 bar/minute, such as less than 0.5 bar/minute, such as less than 0.1 bar/minute.

In general, all pressure regulation should be performed with an appropriate caution to avoid damaging the cohesion of the rubber containing waste material, which means that decompression of the rubber containing waste material preferably should be performed at a rate less than 10 bar/minute, such as less than 5 bar/minute, such as less than 2 bar/minute, such as less than 0.5 bar/minute, such as less than 0.1 bar/minute.

In one embodiment, the method further comprises the step of subjecting the waste material to a impregnating step wherein the waste is treated with an impregnation composition preferably comprising one or more monomers selected from the group consisting of silicon containing monomers such as silanes, such as TEOS (tetraethylorthosilicate or tetraethoxysilane) or chloro- or alkoxy-functional silanes, olefins such as ethylene, propylene, styrene, vinylpyrrolidone, oxygen- and nitrogen-containing monomers such as acrylic derivatives, e.g. acrylic ester and acrylic acid, methacrylic acid and -ester, urethanes, mono- and di-functional alcohols, carboxylic acids, amines, diamines, isocyanates, epoxides, aromatic compounds such as aromatics carrying substituents such as alkyl groups and sulfonated aromatics, aromatic resins, imidazol and imidazol derivatives, pyrazoles, quartenary ammonium compounds, polyurethane prepolymers and epoxy resins. As mentioned, such a treatment may increase surface adhesion properties. Furthermore, the impregnated compounds may modify the surface characteristics e.g. surface tension and modify the colour of the rubber

Other useful impregnation compositions include epoxy-compounds such as Bisphenol-A derivatives, epoxides and diamides.

The impregnation may in principle be performed at any time, but in order not to remove the once impregnated components it is desired that the impregnation step is performed simultaneously with the extraction step, after the extraction step or overlapping with the extraction step. If the impregnation step is performed simultaneously with the extraction step, the impregnation compounds may be present in the extraction solvent. Alternatively the impregnation solvent is introduced in an impregnation solvent preferably comprising carbon dioxide. The impregnation solvent may comprise surfactant for increasing the solubility of the impregnation compounds. Example of useful surfactants and amounts thereof are the surfactants disclosed above for the extraction solvent.

The impregnated components may be polymerized to form an interpenetrating network rubber material. For facilitating the polymerization a radical former or other polymerization initiator may be incorporated into the rubber material simultaneously with the impregnation solvent.

The rubber material produced may preferably comprise less than 0.5% by weight, preferably less than 0.1% by weight, preferably less than 0.01% by weight, and even more preferably essentially free of alkylated aromatic oils and heavy metals in the form of inorganic and organic salts. Since it is not necessary to use organic extraction solvent, the rubber material according to the invention may be essentially free of organic solvents.

In one embodiment, the rubber waste material in granulated form is placed in a pressure reactor and extracted using carbon dioxide, optionally in combination with surfactants soluble in carbon dioxide (such as silicone based, ester based. Various machine designs are available to perform the extraction both under supercritical conditions and under liquid but pressurized conditions. For further information concerning extraction with supercritical process reference is made to the co-pending application PCT/DK/0300052.

The extracted residues may be collected in pure form following the removal of excess carbon dioxide and are available for recycling or special incineration.

In one embodiment, where a further modification of the rubber granulates is desired, monomers or pre-monomers may be added during the high pressure process. Such materials can in one embodiment be polymers or monomers which later can be polymerized by application of heat, radiation, or the like.

The purpose of impregnation is to make the granulate compatible with the matrix material in which the granulate shall be placed. Styrene is suitable for making the granulate compatible with thermoplastic elastomers, epoxy is suitable for achieving compatibility with epoxy based paints or floorings, both styrene and epoxy are suitable for achieving compatibility with asphalt, polyolefins make granulate suitable for integration into thermoplastics.

Thus, in one embodiment, styrene is used as impregnation monomer and later converted to polystyrene which is dispersed in the rubber in the form of an interpenetrating network (IPN). High concentrations can be achieved, such as up to 100% of the rubber weight, however, for economical reasons it is useful to limit the styrene weight to less than 10 or less than 5% of the rubber weight. This modified granulate shows significantly increased compatibility and cohesion with SEBS, SBS and SIS type thermoplastic elastomers. (Example 1). Equally, asphalt is thickened by this type of granulate (Example 2).

In one embodiment, epoxy (non-limiting example bisphenol-A based diglycidyl ether, “Epicote 828”) and hardener (non-limiting example polyaminoamid dissolved in xylene, amine value 170) are impregnated into rubber granulate at concentrations of more than 0.2%. The granulate modified in this manner shows excellent cross-linkability and adhesion in epoxy and bituminous matrices.

The embodiments described shall be non-limiting. In principle, any monomer or prepolymer of, e.g. polypropylene, polyisoprene, urethanes, polyglycols etc. can be formed from suitable prepolymers if those are soluble in pressurized carbon dioxide and can be precipitated under conditions obvious for the one skilled in the art.

After all impregnations, it is useful to flush the reactor content with pure carbon dioxide in order to remove unreacted monomer—in case a polymerization has been carried out during the process. If it is chosen to carry out the polymerization separately, one may chose to flush the granulate with carbon dioxide, if the residual monomer concentration is deemed too high.

It is preferred that the pressure during and after the impregnation step is regulated to avoid damaging the cohesion of the rubber containing waste material as described above. Thus, decompression of the rubber containing waste material should preferably be performed at a rate less than 10 bar/minute, such as less than 5 bar/minute, such as less than 2 bar/minute, such as less than 0.5 bar/minute, such as less than 0.1 bar/minute.

In one embodiment of the method according to the invention the pressure during and after the extraction step is regulated to avoid damaging the cohesion of the rubber containing waste material, and any decompression of the rubber containing waste material is performed at a rate less than 10 bar/minute, such as less than 5 bar/minute, such as less than 2 bar/minute, such as less than 0.5 bar/minute, such as less than 0.1 bar/minute.

After removal from the reactor, the granulate is ready for use.

Suitable use of the rubber material includes asphalt modification, plastic modification, fillers, elastic fillers, rubber modification, vulcanisable fillers, fillers for coatings, paints and marine paints,

The invention also relates to a rubber material comprising less than 0.5% by weight, preferably less than 0.1% by weight, preferably less than 0.01% by weight, and even more preferably essentially free of alkylated aromatic oils and heavy metals in the form of inorganic and organic salts.

This rubber material can be obtained by the method according to the invention.

The rubber material has maintained most or even all of its elasticity and its cohesiveness, and simultaneously the amount of alkylated aromatic oils and heavy metals in the form of inorganic and organic salts is very low or it is even not present.

### EXAMPLES

### Example 1

Extraction process: Carbon dioxide is recycled by distillation, allowing facile separation of residues. Typically, rubber powder has been extracted using supercritical carbon dioxide at 150-300 bar and 40 to 80° C. for times in the order of 30 minutes. Liquid carbon dioxide at 0-30° C. and 15-50 bars may be used, albeit preferably in combination with surfactants, according to the art described among other in U.S. Pat. No. 6,461,387 and the references cited therein. A black, essentially non-smelling free-flowing powder is obtained after the extraction.

### Example 2

Impregnation process: The monomers and prepolymers mentioned above, with the exception of diamide and diamine hardeners for epoxy, are all soluble in carbon dioxide and show a strong tendency to get absorbed by rubber granulates. Therefore, impregnation proceeds at the same pressure and temperature conditions as the extraction within short time periods, typically less than 20 minutes. Compounds of low solubility can be impregnated using co-solvents such as isopropanol, acetone, water and the like; alternatively non-ionic, ionic or silicone-based surfactants may be employed at about 1% wt of the material to be impregnated.

### Example 3

Polymerization: Styrene polymerization proceeds following the co-impregnation of suitable radical starters such as AIBN (azo-bis-isobutyronitril) at 80° C. under CO2 pressure. Other vinyl compounds can be polymerized accordingly or using other textbook type polymerization methods such as radiation (UV, electron beam, gamma-radiation).

### Example 4

Use in asphalt: upon admixture to asphalt, at all concentrations increased elongation at break, reduced compression set and higher elasticity is observed with respect to reference samples prepared from non-extracted rubber granulate. Merely extracted rubber is preferred for low performance asphalt types, styrene-modified rubber is preferred for SBS modified asphalt.

### Example 5

Use in epoxy paints: upon admixture to heavy duty, e.g. marine or protective paints increased elasticity, increased elongation at break and higher impact strength is measured as compared to reference samples. Preferred are epoxy-modified rubber granules due to their excellent miscibility with the paint.

### Example 6

Use in polymer modification: extracted rubber is found to be easily dispersible in polyolefins. Higher impact strength is observed for polyethylene and polypropylene modification. A mixture of up to 80% wt rubber granules with polyolefins is injection-mouldable and extrudable.

### Example 7

Use as filler in production of mainly virgin-rubber: extracted and impregnated rubber can be co-vulcanized into virgin rubber articles such as car tyres, conveyor belts and the like. Increased adhesion of the rubber granules with the rubber matrix is observed in comparison to admixture of raw rubber granulates, indicating higher cross-linking efficiency.

1-51. (canceled)

52. A method of providing a rubber material from a rubber containing waste material, the method comprises the step of subjecting the waste material to a treatment with an extraction solvent in a reactor at a pressure above atmospheric pressure, wherein the extraction solvent comprises an effective amount of carbon dioxide.

53. A method according to claim 52, wherein the extraction solvent comprises at least 80% by weight of carbon dioxide.

54. A method according to claim 52, wherein the method comprises the step of subjecting the waste material to a treatment with an extraction solvent in a reactor at a pressure of at least 5 bars.

55. A method according to claim 52, wherein the extraction step comprises subjecting the rubber containing waste material to a flow of the extraction solvent.

56. A method according to claim 55, wherein the average flow through the reactor during the extraction step preferably being at least 0.5 kg/min of extraction solvent per kg rubber containing waste material.

57. A method according to claim 52, wherein the extraction step comprises subjecting the rubber containing waste material to a dynamic extraction by providing a continuous flow of the extraction solvent.

58. A method according to claim 52, wherein the extraction step comprises subjecting the rubber containing waste material to a stepwise static extraction by providing at least one stepwise change of solvent between static extraction steps, by the stepwise change of solvent so that at least 50% by volume of the solvent in the reactor being changed during the stepwise change of solvent.

59. A method according to claim 58, wherein the stepwise change of solvent between static extraction steps includes a flow of solvent through the reactor over a stepwise change period whereby the flow of solvent through the reactor includes at least 50% by volume of the solvent in the reactor prior to the stepwise change period.

60. A method according to claim 52, wherein the extraction step comprises subjecting the rubber containing waste material to a combined dynamic and static extraction by providing a continuous flow of the extraction solvent during the dynamic extraction and essentially no solvent flow at the static extraction.

61. A method according to claim 60, wherein the extraction step comprises at least one static extraction step, each static extraction step being performed for a static extraction step period which is at least 1 minute.

62. A method according to claim 61, wherein the extraction step comprises at least 2 static extraction steps, each static extraction step being performed for a static extraction step period, wherein the respective static extraction step periods have a length which is different from each other.

63. A method according to claim 60, wherein the extraction step comprises at least one dynamic extraction step, each dynamic extraction step being performed for a dynamic extraction step period which is at least 3 minutes.

64. A method according to claim 60, wherein the extraction step comprises at least 2 dynamic extraction steps, each dynamic extraction step being performed for a dynamic extraction step period, wherein the respective dynamic extraction step periods have a length which is different from each other.

65. A method according to claim 60, wherein the extraction step comprises at least two dynamic extraction steps, the average solvent flow through the reactor in the respective dynamic extraction steps being essentially equal to each other.

66. A method according to claim 60, wherein the extraction step comprises at least two dynamic extraction steps, the average solvent flow through the reactor in the respective dynamic extraction steps differs from each other, preferably the flow of solvent decreases from one extraction step to a subsequent extraction step.

67. A method according to claim 60, wherein the extraction step comprises alternating dynamic and static extraction steps, including at least one dynamic step with a dynamic step period of at least 3 minutes, with intermediate static extraction step(s) with respective static extraction step periods of between 0.5 and 30 minutes.

68. A method according to claim 52, wherein the extraction step is performed for at total extraction period of least 10 minutes.

69. A method according to claim 52, wherein the pressure is essentially constant during the extraction step.

70. A method according to claim 52, wherein the pressure varies during the extraction step.

71. A method according to claim 52, wherein the being at least 10 bars during the extraction step.

72. A method according to claim 52, wherein the volume of the reactor is between 1.5 and 500 L per Kg rubber containing waste material.

73. A method according to claim 52, wherein the temperature at the treatment step is at least 5° C.

74. A method according to claim 52, wherein the extraction step is performed for a sufficient time to extract at least 0.5% by weight of the rubber part of the rubber containing waste material.

75. A method according to claim 52, wherein the extraction solvent comprises a surfactant.

76. A method according to claim 75, wherein the extraction solvent comprises a surfactant selected from the group consisting of hydrocarbon and fluorocarbon having a HLB value less than 15, where the HLB value is determined according to the formula:
HLB=7+Σ(hydrophilic group numbers)−Σ(lipophilic group numbers).

77. A method according to claim 75, wherein the extraction solvent comprises a surfactant selected from the group consisting of perhalogenated surfactants, polypropylene glycol surfactants, perhaloether surfactants, polydimethylsiloxane surfactants and mixtures thereof.

78. A method according to claim 75, wherein the extraction solvent comprises a surfactant selected from the group consisting of poly(1,1′-dihydroperfluorooctyl acrylate)-b-(poly)styrene, poly(1,1′-dihydroperfluorooctyl acrylate-b-styrene), poly(1,1′-dihydroperfluorooctyl acrylate-b-methyl methacrylate), poly(1,1′-dihydroperfluorooctyl acrylate-b-vinyl acetate), poly(1,1′-dihydroperfluorooctyl acrylate-b-vinyl alcohol), poly(1,1′-dihydroperfluorooctyl methacrylate-b-styrene), poly(1,1′-dihydroperfluorooctyl acrylate-co-styrene), poly(1,1′-dihydroperfluorooctyl acrylate-co-vinyl pyrrolidone), poly(1,1′-dihydroperfluorooctyl acrylate-co-2-ethylhexyl acrylate), poly(1,1′-dihydroperfluorooctyl acrylate-co-2-hydroxyethyl acrylate), poly(1,1′-dihydroperfluorooctyl acrylate-co-dimethylaminoethyl acrylate), poly(styrene-g-dimethylsiloxane), poly(methyl acrylate-g-1,1′-dihydroperfluorooctyl methacrylate), poly(1,1′-dihydroperfluorooctyl acrylate-g-styrene), perfluorooctanoic acid, perfluoro(2-propoxy propanoic) acid and mixtures thereof.

79. A method according to claim 75, wherein the extraction solvent comprises at least 0.001 by weight of one or more surfactants.

80. A method according to claim 52, wherein the extraction solvent comprises a co-solvent.

81. A method according to claim 80, wherein the extraction solvent comprises a co-solvent selected from the group consisting of methane, ethane, propane, ammonium butane, n-pentane, hexanes, cyclohexane, n-heptane, ethylene, propylene, methanol, ethanol, isopropanol, benzene, toluene, xylenes, chlorotrifluoromethane, trichlorofluoromethane, perfluoropropane, chlorodifluoromethane, sulfur hexafluoride, nitrous oxide, N-methyl pyrrolidone, acetone, organosilicones, terpenes, paraffins, and mixtures thereof.

82. A method according to claim 79, wherein the extraction solvent comprises up to about 50% by weight of co-solvent.

83. A method according to claim 52, wherein the waste material comprises vulcanized rubber.

84. A method according to claim 52, wherein the waste material being subjected to a granulating step prior to the extraction step.

85. A method according to 52, wherein the rubber containing waste material is provided with its final granular size prior to the extraction step.

86. A method according to claim 85, wherein the rubber containing waste material, has a granular size between 100 and 500 μm measured by sieving prior to the extraction step.

87. A method according to claim 86, wherein the rubber containing waste material, has a granular size of less than 5000 μm measured by sieving prior to the extraction step.

88. A method according to claim 52, wherein the pressure at the termination of the extraction step is regulated to atmospheric pressure sufficiently slowly to avoid damaging the rubber containing waste material.

89. A method according to claim 88, wherein the pressure at the termination of the extraction step is regulated to atmospheric pressure at a speed less than 10 bar/minute.

90. A method according to claim 52, further comprising the step of subjecting the waste material to a impregnating step wherein the waste is treated with an impregnation composition.

91. A method according to claim 90, wherein the impregnating step comprises treating the waste material with an impregnation composition comprising one or more monomers selected from the group consisting of silicon containing monomers, olefins, oxygen- and nitrogen-containing monomers, urethanes, mono- and di-functional alcohols, carboxylic acids, amines, diamines, isocyanates, epoxides, aromatic compounds, aromatic resins, imidazol and imidazol derivatives, pyrazoles, quartenary ammonium compounds, polyurethane prepolymers and epoxy resins.

92. A method according to claim 91, wherein the impregnation composition comprises one or more of the compounds styrene, vinyl-compounds, epoxy-compounds, epoxides, diamines, diamides, pyrrolidones, di- or polyacids and imidazol.

93. A method according to claim 90, wherein the impregnation step is performed simultaneously with the extraction step, after the extraction step or overlapping with the extraction step.

94. A method according to claim 90, comprising the additional step of subjecting the impregnated components which have been impregnated into or onto the rubber material to polymerization to thereby form an interpenetrating network rubber material.

95. A method according to claim 90, wherein the pressure during and after the impregnation step is regulated to avoid damaging the cohesion of the rubber containing waste material.

96. A method according to claim 95, wherein the pressure during and after the extraction step is regulated to avoid damaging the cohesion of the rubber containing waste material, decompression of the rubber containing waste material being performed at a rate less than 10 bar/minute.

97. A rubber material obtained by the methods as defined in 52.

98. A rubber material according to claim 97, wherein the rubber material comprises less than 0.5% by weight of alkylated aromatic oils and heavy metals in the form of inorganic and organic salts.

99. A rubber material according to claim 98, wherein the rubber material is essentially free of organic solvents.

100. A modifyer for asphalt comprising a rubber material according to claim 97.

101. A tyer comprising a rubber material according to claim 97.

102. A paint comprising a rubber material according to claim 97.

103. A method of producing a rubber material from a rubber containing waste material with residues, the method comprises the step of extracting at least 0.5% by weight of the residues of the rubber, using an extraction solvent in a reactor at a pressure above atmospheric pressure, wherein the extraction solvent comprises at least 80% by weight of carbon dioxide, the pressure is regulated sufficiently slowly to avoid damaging the rubber containing waste material.

104. A method according to claim 103, wherein the pressure is regulated so that decompression of the rubber containing waste material being performed at a rate less than 10 bar/minute.
